(19) United States
(12) Patent Application Publication
(10) Pub. No.: US 2008/0098876 A1
(43) Pub. Date: May 1, 2008

(54) HOME-BASED EXERCISE TRAINING METHOD AND SYSTEM GUIDED BY AUTOMATICALLY ASSESSMENT AND SELECTING MUSIC

(76) Inventors: Han-Pin Kuo, Gueishan Township (TW); Wen-Te Liu, Gueishan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/754,413

(22) Filed: May 29, 2007

(30) Foreign Application Priority Data
Oct. 25, 2006 (TW) 095139404

(51) Int. Cl. G10H 7/00

(52) U.S. Cl. 84/609

(57) ABSTRACT

A method and a system using the same for automatically selecting music for a patient to exercise at home following proper tempo music without supervising are disclosed. The method comprises: receiving at least one initial physical data of the patient; generating a basic tempo music according to the at least one initial physical data; providing a plurality of music with different tempo according to the basic tempo music; receiving at least one exercise data of the patient including an exercise time (or duration) of the patient exercising following the basic tempo; and automatically selecting one of the plurality of music according to the at least one exercise data for the patient to exercise following the selected tempo music.

### BACKGROUND OF THE INVENTION

1. Field of the Invention

The present invention relates to a method and a system for automatically selecting music, particularly, to a method and a system using the same for home-based exercise training guided by automatically assessment and selecting music.

2. Description of the Prior Art

Before 1992, the general medical system thought that “exercise” might hurt a patient especially the patient who has the heart or lung related disease. Therefore, in the early days, exercise assessment is applied on athletes only. However, till 1992, “Shuttle Walking Test” was developed for assessing a patient as one of the “rehabilitation systems”. In general, the exercise strength is based on the oxygen consumption. And, according to the traditional information, it can be understood that the oxygen consumption is proportional to the speed of the exercise. Accordingly, in a hospital, a patient can be assessed by his/her exercise such as walking distance and time.

In short, Shuttle Walking Test is used for a patient to walk a designated distance (such as 10 meters) back and forth until the patient can't go anymore (for example, can't breath smoothly (dyspnea)) . Then, a max speed (a max exercise strength) of the walker (the patient) can be recorded under supervision of a medical person. According to some factors such as the max speed, physical data (height, weight, age, and sex), etc, a doctor may preset a proper exercise speed (such as the 80% of the max exercise strength) for the patient to walk (exercise) continuously for rehabilitation.

Continuously rehabilitation of the patient can provide some useful information for the doctor to diagnose. For example, the doctor may change the prescription or the dosage according to the exercise status of the patient. Furthermore, the patient may be recovered according to such rehabilitation system, and thus, the medical sources can be reduced. The traditional rehabilitation system requires the patient to exercise in the hospital, i.e. the patient relies on the supervision assistance of the medical persons. For example, the exercise strength of the patient needs to be supervised under the medical person. Hence, the rehabilitation for the patient is not only relied on the manpower of the hospital, but also relied on the motivation of the patient to come to the hospital.

For the chronic patient such as asthma, diabetes or hypertension, continuously monitoring his/her status can efficiently prevent sudden aggravation. The chronic patient cannot only rely on receiving medical suggestion in the clinical return visit periodically (such as every four to twelve weeks). The periodically outpatient clinical services or the long-period prescription can only provide passive defenses, instead of active controlling by doctors or medical system for any possible serious situation of the patient. In addition, periodically outpatient services can't distribute the medical sources efficiently. Moreover, when the patient sees the doctor for clinical return visit, he/she maybe not having any aggravation symptom. Thus, the doctor could not provide an efficient therapy.

Therefore, there is a need of rehabilitation system for the patient to assess his/her own disease. Because the patient can automatically assess his/her own disease and the medical system can synchronously get the assessment, the medical sources can be distributed efficiently. Furthermore, it can achieve the objection of recovering the patient.

### SUMMARY OF THE INVENTION

One aspect of the present invention is to solve the above-mentioned problem. Therefore, the present invention provides a method and a system using the same for home-based exercise training guided by automatically assessment and selecting music. Furthermore, it can efficiently distribute the medical source.

The method of automatically selecting music according to the present invention is adopted to selectively provide proper tempo music to a patient without any supervision, wherein the proper tempo music is used for the patient to exercise according to the tempo of the proper tempo music. The method comprises: receiving at least one initial physical data of the patient; generating a basic tempo music according to the at least one initial physical data; providing a plurality of music with different tempo according to the basic tempo music; receiving at least one exercise data of the patient including an exercise time (or duration) of the patient exercising following the basic tempo; and automatically selecting one of the plurality of music according to the at least one exercise data for the patient to exercise following the selected tempo music.

Preferably, the method of this invention may further comprise storing the at least one exercise data.

In addition, the system of automatically selecting music according to the present invention is adopted to selectively provide proper tempo music to a patient without any supervision, wherein the proper tempo music is used for the patient to exercise according to the tempo of the proper tempo music. The system comprises an exercise status database, a control unit, and a playing apparatus. The exercise status database stores at least one exercise data of the patient. The control unit is connected with the exercise status database for automatically selecting a proper music instruction based on the exercise data. The playing apparatus stores with a plurality of music with different tempo. The playing apparatus receives the selected proper music instruction to selectively play one of the pluralities of music with a specific tempo for the patient to exercise following the specific tempo. Furthermore, the playing apparatus may generate and transmit the at least one exercise data to the control unit. For example, it may transmit the exercise data (including exercise time (or duration), dyspnea rating data, or the patient's heart rate) Therefore, after obtaining the exercise data, when the patient is going to exercise on the next day of the exercise data obtaining, the control unit transmits the proper music instruction based on the exercise data to the playing apparatus for selectively playing one of the pluralities of music with the specific tempo for the patient to exercise following the specific tempo.

### BRIEF DESCRIPTION OF THE DRAWINGS

FIG. 1 illustrates a system architecture diagram of a system for home-based exercise training guided by automatically assessment and selecting music in accordance with an embodiment of the present invention.

FIG. 2A and FIG. 2B show surveys for the exercise data and physical state data of the patient in accordance with a system for home-based exercise training guided by automatically assessment and selecting music of the present invention.

FIG. 3 shows a process flow chart of a method for home-based exercise training guided by automatically assessment and selecting music of the present invention.

### DETAILED DESCRIPTION OF THE INVENTION

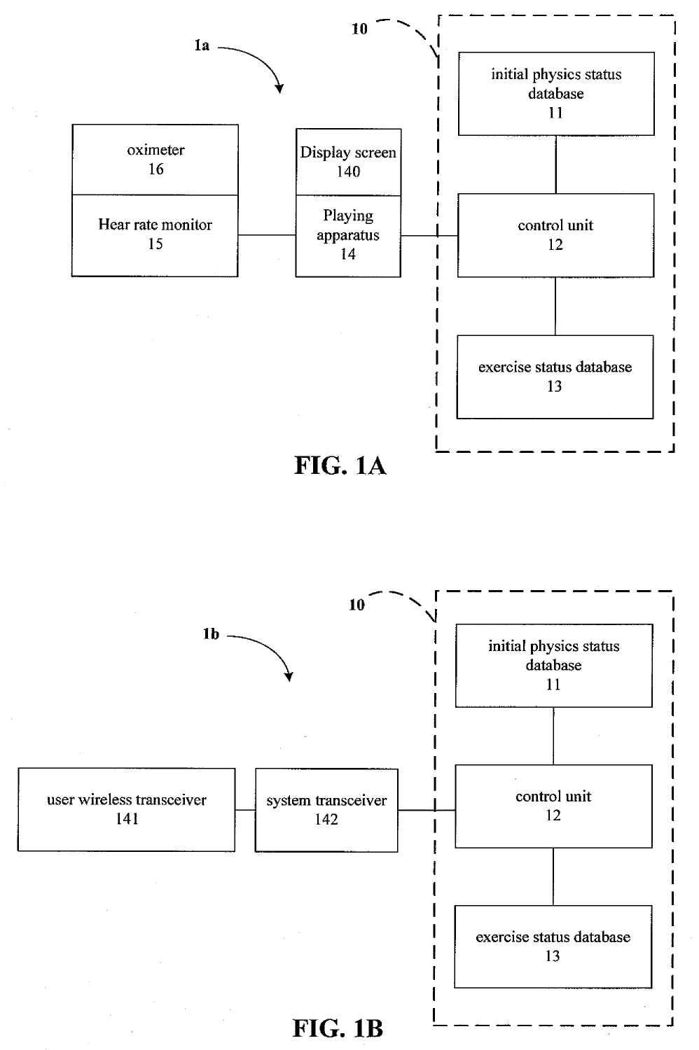

Please referring to FIG. 1A, a system for home-based exercise training (such as walk training) guided by automatically assessment and selecting music for a patient (such as a chronic disease patient) according to an embodiment of the present invention is illustrated. The system 1a according to the present invention comprises an exercise status database 13, a control unit 12, and a playing apparatus 14. Preferably, the system 1a further comprises an initial physical status database 11, a heart rate monitor 15, and/or an oximeter 16. For example, a portable heartbeat oximeter can be put on the patient's finger for measuring his/her heart rate or oxyhemoglobin and deoxygenated hemoglobin in blood, thus the heart rate monitor 15 and the oximeter 16 can be combined as one portable heartbeat oximeter. The playing apparatus 14 may preferably have function of General Packet Radio Service (GPRS), Global System for Mobile Communication (GSM), Wireless Local Area Network (WLAN), or the like. The patient can be tested for his/her level (speed) and steps per shuttle (initial physical data of the patient) for initializing the walking test in the hospital. For example, at first, the patient walks to and fro in a specific distance shuttles with a specific tempo until the patient cannot walk any more (such as the patient cannot follow the tempo to walk and not breath smoothly) Then, the number of the steps and speed of the patient can be measured, and thus his/her maximum intensity of exercise (walking speed) can be obtained. For example, a doctor can set a level for the patient from TABLE 1, for example according to 80% of the maximum intensity. The TABLE 1 is a corresponding level according to a conventional shuttle walking test (as shown in below of conventional table). The TABLE 1 has modified some differential speed to a specific value (such as 0.25/hr) for simplifying the calculation. Those people skilled in this art will be understood that the levels of the Shuttle Walking Test is graded for different speed from slow to fast as an index.

10 m shuttle walking test - 60 s increments

| | | | | | No. of | | |
|---|---|---|---|---|---|---|---|
| | Speed | | | | shuttles | | Distance |
| level | m/s | km/h | mph | time/shuttle(s) | level | total | m |
| 1 | 0.50 | 1.80 | 1.12 | 20.00 | 3 | 3 | 30 |
| 2 | 0.67 | 2.41 | 1.50 | 15.00 | 4 | 7 | 70 |
| 3 | 0.84 | 3.03 | 1.88 | 12.00 | 5 | 12 | 120 |
| 4 | 1.01 | 3.63 | 2.26 | 10.00 | 6 | 18 | 180 |
| 5 | 1.18 | 4.25 | 2.64 | 8.57 | 7 | 25 | 250 |
| 6 | 1.35 | 4.86 | 3.02 | 7.50 | 8 | 33 | 330 |
| 7 | 1.52 | 5.47 | 3.40 | 6.67 | 9 | 42 | 420 |
| 8 | 1.69 | 6.08 | 3.78 | 6.00 | 10 | 52 | 520 |
| 9 | 1.86 | 6.69 | 4.16 | 5.46 | 11 | 63 | 630 |
| 10 | 2.03 | 7.31 | 4.54 | 5.00 | 12 | 75 | 750 |
| 11 | 2.20 | 7.92 | 4.92 | 4.62 | 13 | 88 | 880 |
| 12 | 2.37 | 8.53 | 5.30 | 4.29 | 14 | 102 | 1020 |

TABLE 1

| | | time/per |
|---|---|---|
| | Speed | shuttle |
| Level | (km/hr) | (Sec.) |
| 1 | 2.25 | 16.000 |
| 2 | 2.50 | 14.400 |
| 3 | 2.75 | 13.091 |
| 4 | 3.00 | 12.000 |
| 5 | 3.25 | 11.077 |
| 6 | 3.50 | 10.286 |
| 7 | 3.75 | 09.600 |
| 8 | 4.00 | 09.000 |
| 9 | 4.25 | 8.471 |
| 10 | 4.50 | 8.000 |
| 11 | 4.75 | 7.579 |
| 12 | 5.00 | 7.200 |
| 13 | 5.25 | 6.857 |
| 14 | 5.50 | 6.545 |
| 15 | 5.75 | 6.261 |
| 16 | 6.00 | 6.000 |

(per shuttle = 10 meters)

For example, if the patient his maximum intensity is measured as 4.86 km/hr, and he walks 16 steps per shuttle (average). Then, 80% of the maximum intensity is 3.78 km/hr, and as shown in TABLE 1, it falls in Level 7.

The initial physical status data (such as the above measurement of the level and steps) of the patient can be further stored in the initial physical status database 11. The control unit 12 is connected with the exercise status database 13 and the initial physical status database 11 respectively. Furthermore, according to the physical status data in the initial physical status database 11, the control unit 12 can calculate for a proper tempo for the patient to exercise by following the proper tempo. The control unit 12 can first provide a basic music instruction. For example, the control unit 12 can calculate the required tempo for the patient according to the following formula 1.

$$\frac{( \frac{level + 8}{4} ) * \frac{1000}{60}}{10 / step} \qquad Formula 1$$

wherein the level is looked up in TABLE 1, and the step is the number steps of the patient walked in one shuttle.

In the above example, the patient is in Level 7, and walking step is 16 steps per shuttle. According to the Formula 1, it can get the result of 100 beats per minute (tempo). Therefore, according the basic tempo, a plurality of music with different tempos, such as per minute 90 beats, 100 beats, 105 beats. . . etc, can be stored in the playing apparatus 14. In order to have simplified calculation, the music with different tempos stored in the playing apparatus 14 can be differenced with same beats (such as 5 beats); however, it is not used to limit the present invention, which may have variety differentials for tempos.

For example, the control unit 12 provides the basic music instruction of 100 beats to the playing apparatus 14. In another word, for the first time that the patient uses the playing apparatus 14 is to play the music with a basic tempo (such as 100 beats) based on the basic music instruction. The patient exercises following the tempo (such as 100 beats) of the music until he/she cannot follow the tempo (or cannot breath smoothly).

The exercise status data may further comprise time data, heart rate data, the dyspnea rating data, or the like.

When the patient starts to play the playing apparatus 14, the playing apparatus 14 sends initial signal to the control unit 12. And when the patient turns off the playing apparatus 14, the playing apparatus 14 sends end signal to the control unit 12. According to the initial signal and the end signal, the control unit 12 can calculate an exercise time (or duration) of the patient.

The heart rate of the patient can be inputted into the playing apparatus 14. The heart rate monitor 15 may connect to the playing apparatus 14 electronically; however, it is not used to limit the present invention. The data of the heart rate can be inputted by manual, instead. Furthermore, the patient can input his/her dyspnea rating data (will be described more detail in the following) into the playing apparatus 14. Similarly, the playing apparatus 14 can send the exercise status data (i.e. the inputted data) to the control unit 12.

The control unit 12 can further control all the exercise status data to be stored into the exercise status database 13, which can be a medical history of the patient for doctor's reference.

The playing apparatus 14 may be a cell-phone, a MP3 player, a Walkman, or the like that having a receiver thereon. The control unit 12 can use communication technology such as GSM, GPRS, or the like to transmit one or more instructions to the playing apparatus 14. Alternatively, as shown in FIG. 1B, the playing apparatus 14 may be a user wireless transceiver 141 for receiving instruction(s) from the control unit 12 through a system transceiver 142. The system transceiver 142 can be used for receiving and/or transmitting the inputted data from the user wireless transceiver 141 to the control unit 12. The communication of, for example, the RF or Bluetooth technology can be used for the user wireless transceiver 141 to transmit the exercise status data to the system transceiver 142. Alternatively, the inputted data can be transmitted to a PC (not shown) from the user wireless transceiver 141 via WLAN. The communication technology is well known to those people skilled in the art, so it is not required to describe in detail.

The initial physical status database 11, the control unit 12, and the exercise status database 13 can be integrated on an Internet platform 10. Thus, if it is using a GPRS cell-phone as the playing apparatus 14, all data in the GPRS cell-phone can be sent to the Internet platform 10 via wireless communication. Alternatively, if it is using the user wireless transceiver 141 as the playing apparatus 14, all data in the user wireless transceiver 141 can be sent to the Internet platform 10 through the system transceiver 142 or the PC via WLAN.

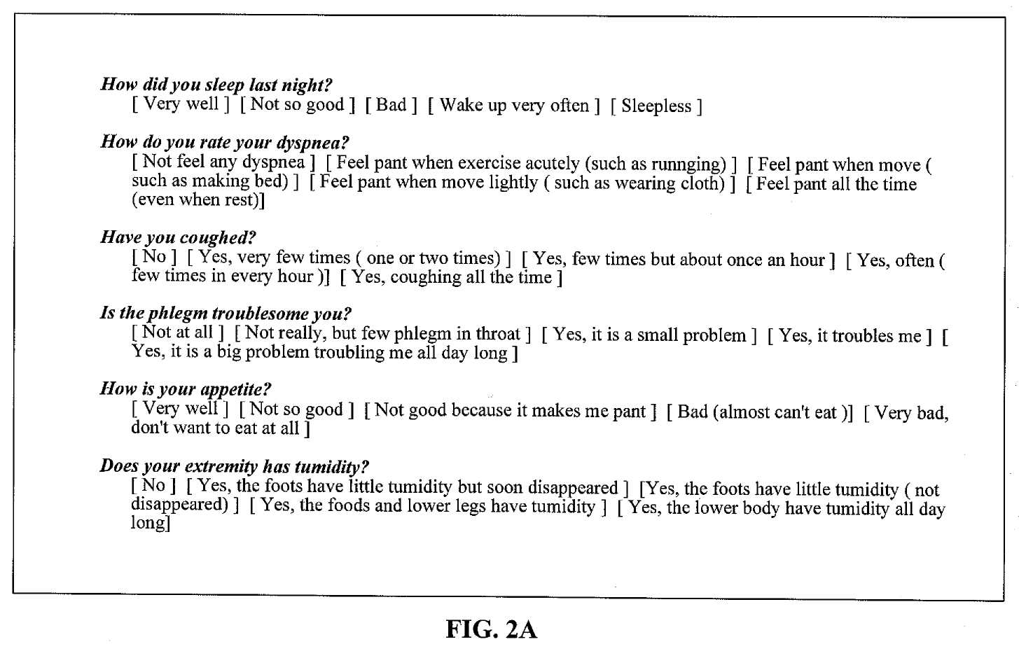

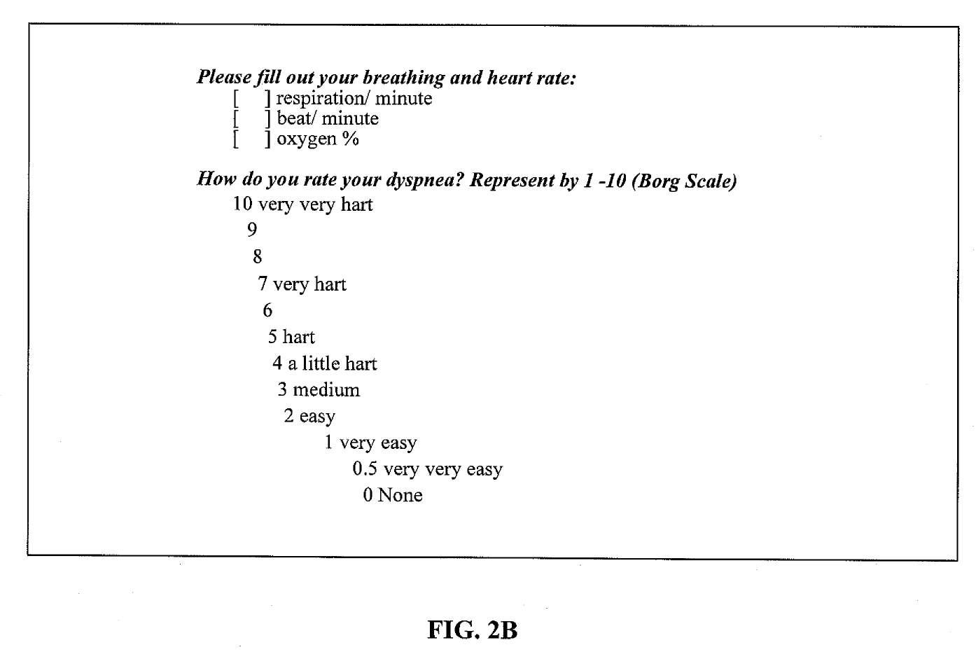

In addition, there are some other factors that may influence the exercise. The dyspnea rating of the patient can be divided 1-10 degree according to the BORG SCALE. The patient can input his/her exercise status data by filling one or more surveys displayed on a screen 140 of the playing apparatus 14. The surveys, as shown in FIG. 2A and FIG. 2B, can be stored in the playing apparatus for the patient to fill before and/or after exercising. The exercise status data can be obtained and transmitted to the control unit 12 from the playing apparatus 14, and can be stored in the exercise status database 13.

If the patient keeps endurance exercise at anywhere he/she wanted regularly, his/her intensity of exercise can be increased. When the patient has better intensity of exercise, the tempo should be a little bit quicker accordingly. According to the exercise status data (including such as the heart rate, dyspnea rating, and/or the exercise time (or duration)) stored in exercise status database 13, the control unit 12 can calculate for a proper intensity of exercise for the patient. The control unit 12, therefore, provides a proper music instruction to the playing apparatus 14 for playing with a proper tempo. Then, the patient can exercise following the proper tempo when playing the playing apparatus 14. In other words, the proper music with the proper tempo can be automatically selected from the playing apparatus 14. The patient needs only to turn on the playing apparatus 14. The proper tempo, for example, can be same, such as 5 beats more, or 5 beats less than the one earlier day. That means the basic tempo music may be same as the proper tempo music. The tempo for the patient to exercise is accordance with the exercise status data. According to the doctor's diagnosing, so the basic tempo, the increment or decrement of the differential tempo (such as 5 beats more or less), or the formula of the tempo should be set by the doctor.

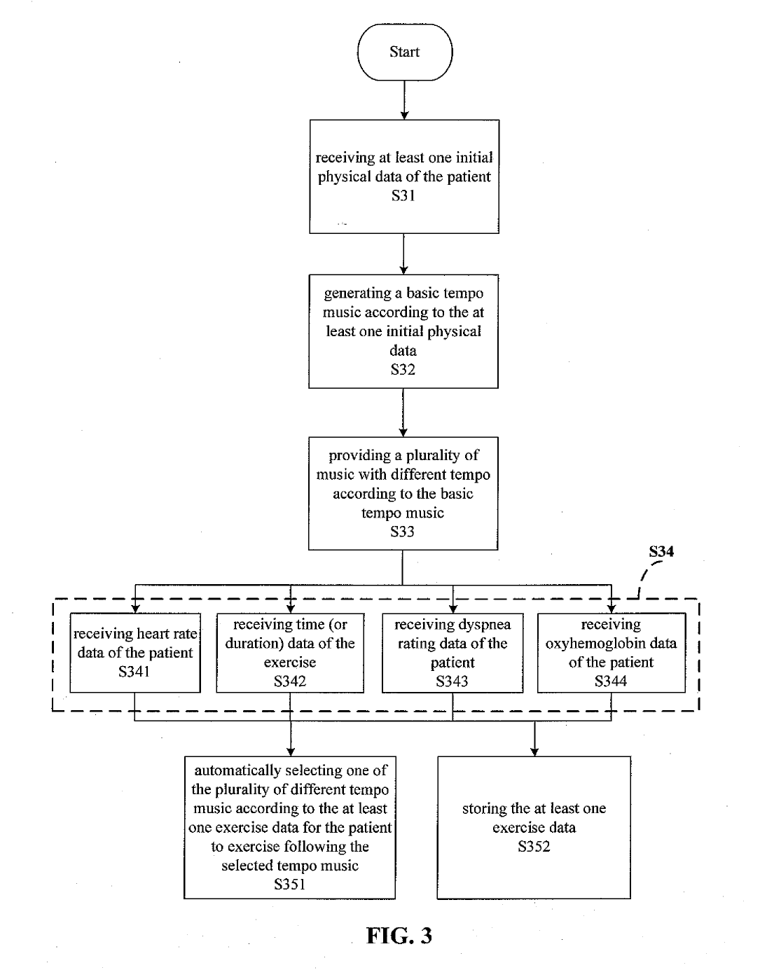

In addition, a method for home-based exercise training guided by automatically assessment and selecting music is provided in accordance with the present invention. The method of automatically selecting music is adopted to selectively provide proper tempo music to a patient without any supervision, wherein the proper tempo music is used for the patient to exercise according to the tempo of the proper tempo music. Please refer to FIG. 3. The method comprises following steps S31-S35. It should be understood that the steps should not be limited for its sequence.

Step S31: receiving at least one initial physical data of the patient. The initial physical data of the patient has described as above of testing in the hospital, for example.

Step S32: generating a basic tempo music according to the at least one initial physical data. As described in above, the basic tempo can be set in accordance with the FORMULA 1 for the patient to exercise following the tempo of the basic tempo music.

Step S33: providing a plurality of music with different tempo according to the basic tempo music. Between any two-tempo music, it can have the same or not the same beat differentials.

Step S34: receiving at least one exercise data of the patient including an exercise time (or duration) of the patient exercising following the basic tempo. As described above, when the patient follows the tempo to walk, the exercise data can be obtained. Receiving the exercise data comprises heart rate S341, time (or duration) of the exercise S342, dyspnea rating S343, and oxyhemoglobin in blood S344.

Step S351: automatically selecting one of the plurality of different tempo music according to the at least one exercise data for the patient to exercise following the selected tempo music. As described above, the proper tempo music will be selected automatically from the playing apparatus 14 (as shown in FIG. 1A).

Preferably, the method of this invention may further comprise the step of storing the at least one exercise data (S352). The exercise data can be used as historical status of the patient for doctors'reference.

According to the above system and method, an experiment has been obtained as following TABLE 2 and TABLE 3 and description, wherein the experiment group (14 persons) used the present invention and the control group (20 persons) did not.

TABLE 2
(Baseline Characteristics)

| | Experiment | Control | |
|---|---|---|---|
| | (N = 14) | (N = 20) | P-Value |
| Age, mean ± SE yr | 69.7 ± 1.9 | 72.2 ± 1.5 | 0.297 |
| Male sex, No. (%) | 14 (100%) | 20 (100%) | 1.000 |
| Body Mass Index, mean ± SE | 24.1 ± 0.8 | 23.5 ± 0.9 | 0.649 |
| Short Form (SF) − 12, | 31.0 (21~39) | 30.0 (26~35) | 0.832 |
| median (min~max) | | | |
| Distance (ISWT), mean ± SE | 281.4 ± 30.6 | 260.0 ± 18.7 | 0.532 |
| FVC, mean ± SE | 1.72 ± 0.09 | 2.04 ± 0.15 | 0.126 |
| FEV1 (L), mean ± SE | 0.96 ± 0.09 | 1.02 ± 0.07 | 0.612 |
| FEV1, (% predicted), | 43.8 ± 4.8 | 46.3 ± 2.8 | 0.635 |
| mean ± SE | | | |
| FEV1/FVC (%), mean ± SE | 55.6 ± 3.9 | 51.6 ± 2.5 | 0.374 |
| IC (L), pre-ISWT, | 1.51 ± 0.08 | 1.72 ± 0.14 | 0.239 |
| mean ± SE | | | |
| IC (L), post-ISWT, | 1.22 ± 0.08 | 1.38 ± 0.13 | 0.334 |
| mean ± SE | | | |
| ΔIC (pre–post ISWT), | 0.29 ± 0.02 | 0.34 ± 0.03 | 0.143 |
| mean ± SE | | | |

(ISWT: incremental shuttle walk test)
(FEV1: Forced Expiratory Volume 1 second)
(FVC: Forced Vital Capacity)
(IC: inspiratory capacity)

TABLE 3
(Exercise tolerance and symptom scores after 12-week endurance exercise training)

| | Experiment | | | Control | | |
|---|---|---|---|---|---|---|
| | | 3 Months | | | 3 Months | |
| | Baseline | later | | Baseline | later | |
| | (N = 14) | (N = 12*) | P-value | (N = 20) | (N = 16**) | P-value |
| Distance | 281.4 ± 30.6 | 353.3 ± 37.9 | <0.01 | 260.0 ± 18.7 | 251.9 ± 21.2 | 0.223 |
| (ISWT), M | | | | | | |
| FEV1 (L) | 0.96 ± 0.09 | 0.97 ± 0.11 | 0.838 | 1.02 ± 0.07 | 0.92 ± 0.07 | 0.287 |
| FEV1 (% | 43.8 ± 4.8 | 44.9 ± 6.2 | 0.829 | 46.3 ± 2.8 | 40.4 ± 2.4 | 0.238 |
| predicted) | | | | | | |
| Duration, | 1552 ± 338 | 2488 ± 388 | <0.01 | — | — | — |
| EWT (sec) | | | | | | |
| Symptoms | 4.5 | 1.0 | <0.01 | — | — | — |
| scores | (1~5) | (0~4) | | | | |

(EWT: Endurance walking test)
(*Withdrawal of 2 patients due to inaccessible; **4 acute exacerbation leading to 2)

From the comparison of TABLE 2 and TABLE 3, it is obvious that exercise tolerance improved after 12-week home-based endurance exercise training according to the present invention.

According to the method and the system of the present invention, the patient can operate (play) the playing apparatus 14 (as shown in FIG. 1A) for home-based exercise training guided by automatically assessment and selecting music. Therefore, the patient needs not to go to the hospital for such training, and the patient may increase his/her willing to be trained. Furthermore, the doctor or the hospital can use the exercise data stored in the exercise status database. Thus, the doctor may understand the change of the symptom of his/her patient for providing more accuracy prescription. The patient can become healthier.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for home-based exercise training guided by automatically assessment and selecting music, the method comprising:
receiving at least one initial physical data of a patient;
generating a basic tempo music according to the at least one initial physical data for the patient to exercise following the basic tempo of the basic tempo music;
providing a plurality of music with different tempo according to the basic tempo music;
receiving at least one exercise data of the patient including an exercise time or duration of the patient exercising following the basic tempo; and
selecting one of the plurality of music according to the at least one exercise data for the patient to exercise following the tempo of the selected music.

2. The method of claim 1, wherein the exercise data further comprises a heart rate data, oxyhemoglobin or deoxygenated hemoglobin data, or a dyspnea rating data.

3. The method of claim 1, further comprising storing the at least one exercise data.

4. The method of claim 1, further comprising receiving initial signal and end signal for calculating the exercise duration of the patient.

5. The method of claim 1, wherein the basic tempo music can be the same or not the same as the proper tempo music.

6. The method of claim 1, wherein the step of receiving the exercise data can use the communication technology of General Packet Radio Service (GPRS), Global System for Mobile Communication (GSM), RF, Wireless Local Area Network (WLAN), or the like.

7. A system for home-based exercise training guided by automatically assessment and selecting music for a patient, the system comprising:
an exercise status database storing at least one exercise data of the patient;
a control unit connected with the exercise status database for selectively providing a proper tempo music instruction based on the at least one exercise data; and
a playing apparatus stored with the a plurality of music with different tempo, the playing apparatus receiving the proper tempo music instruction to play one of the plurality of music for the patient to exercise following the proper tempo of the selected music;
wherein the playing apparatus can provide and transmit the at least one exercise data comprising an exercise time or duration of the patient to the control unit.

8. The system of claim 7, further comprising an initial physical status database connected with the control unit for storing at least one initial physical status data of the patient;
wherein the control unit provide a basic tempo music instruction to the playing apparatus according to the at least one initial physical status data for the playing apparatus to selectively play a basic tempo music of one of the plurality of music, and the at least one exercise data comprising an exercise duration of exercising following the basic tempo music.

9. The system of claim 7, wherein the playing apparatus is capable of sending initial signal and end signal for calculating the exercise duration of the patient.

10. The system of claim 7, further comprising a heart rate monitor for obtaining a heart rate data of beginning or ending of the exercise;
wherein the at least one exercise data further comprises the heart rate data or a dyspnea rating data.

11. The system of claim 10, further comprising an oximeter for obtaining an oxyhemoglobin and deoxygenated hemoglobin data at any time during exercising or beginning of the exercise.

12. The system of claim 11, wherein the playing apparatus further comprises a display screen for displaying at least one survey to be filled for the heart rate data, the dyspnea rating data, or the oxyhemoglobin data of the patient.

13. The system of claim 7, wherein the playing apparatus has the function of communication technology of the communication technology of General Packet Radio Service (GPRS), Global System for Mobile Communication (GSM), RF, Wireless Local Area Network (WLAN), or the like.

14. The system of claim 7, wherein the playing apparatus can be a cell-phone or a user wireless transceiver.

15. The system of claim 14, further comprising a system transceiver for receiving data transmitted from the playing apparatus and forwarding to the control unit.
